(19) United States
(12) Patent Application Publication
(10) Pub. No.: US 2009/0021169 A1
(43) Pub. Date: Jan. 22, 2009

(54) Barrier ribs to reduce reflection of external light and plasma display panel (PDP) including such barrier ribs

(76) Inventor: Tae-Joung Kweon, Suwon-si (KR)

Correspondence Address: ROBERT E. BUSHNELL & LAW FIRM, 2029 K STREET NW, SUITE 600, WASHINGTON, DC, 20006-1004, US

(21) Appl. No.: 12/217,000

(22) Filed: Jul. 14, 2008

(30) Foreign Application Priority Data
Jul. 18, 2007 (KR) 10-2007-0071682

(51) Int. Cl. H01J 17/49; H01J 1/88

(52) U.S. Cl. 313/584; 313/292

(57) ABSTRACT

Barrier ribs to reduce reflection of external light and to minimize brightness losses and a Plasma Display Panel (PDP) including such barrier ribs include a black pigment having a concentration which increases in a direction of light emitted outward from inside of the PDP to effectively reduce reflection of external light.

### CLAIM OF PRIORITY

This application makes reference to, incorporates the same herein, and claims all benefits accruing under 35 U.S.C. §119 from an application for BARRIER RIBS FOR REDUCING LIGHT REFLECTION DUE TO EXTERNAL LIGHT AND PLASMA DISPLAY PANEL COMPRISING THE SAME earlier filed in the Korean Intellectual Property Office on 18 Jul. 2007 and there duly assigned Serial No. 10-2007-0071682.

### BACKGROUND OF THE INVENTION

1. Field of the Invention

The present invention relates to barrier ribs to reduce reflection of external light and a Plasma Display Panel (PDP) including such barrier ribs.

2. Description of the Related Art

Much research has been conducted to develop Plasma Display Panels (PDPs) as one of next generation flat display panels with Liquid Crystal Displays (LCDs), projection displays, and the like. PDPs are flat display panels characterized by a large-scale display structure and high image quality. Particularly, PDPs are self light emitting displays having excellent display properties, such as high brightness, high contrast, wide viewing angle, wide color reproduction range, and thin and large-scale display structure.

In a PDP, ultraviolet rays are generated in a vacuum from an inert gas excited by a high-frequency voltage and fluorescent materials are irradiated by the ultraviolet rays, thereby realizing an image. Research on improving the bright room contrast has been conducted to further improve the image quality of PDPs.

Particularly, the bright room contrast can be improved by reducing reflection of external light. However, reducing the reflection of external light also results in reducing the brightness of the PDP. Thus, there is a need to maximize brightness as well as to reduce reflection of external light.

### SUMMARY OF THE INVENTION

The present invention provides barrier ribs to effectively reduce reflection of external light and to minimize brightness losses in a PDP.

The present invention also provides a PDP including such barrier ribs and thus having improved bright room contrast.

According to one aspect of the present invention, barrier ribs to partition a discharge space to form a plurality of discharge cells of a Plasma Display Panel (PDP) are provided, the barrier ribs including: a glass powder; and a pigment having a varying concentration according to a height of the barrier ribs.

The concentration of the pigment preferably increases in a direction of light emitted outward from inside of the PDP. The pigment absorbs external light. The pigment preferably includes a black pigment. The pigment is preferably selected from a group consisting of CuO, Cr₂O₃, MnO, CoO, Fe₂O₃, (Ti, Mn, Sb)O₂, CuCr₂O₂ and a combination of at least two of these compounds.

The concentration of the glass powder preferably decreases in a direction of light emitted outward from inside of the PDP. The glass powder is preferably selected from a group consisting of SiO₂, ZnO, Bi₂O₃, PbO, B₂O₃, Al₂O₃, ZnO and a combination of at least two of these compounds.

According to another aspect of the present invention, a Plasma Display Panel (PDP) is provided including: a first substrate; and barrier ribs disposed on the first substrate, the barrier ribs including a glass powder and a pigment having a varying concentration according to a height of the barrier ribs.

The concentration of the pigment preferably increases in a direction of light emitted outward from inside of the PDP.

The barrier ribs preferably include a pigment forming a subtractive mixture with the first substrate.

The concentration of the pigment preferably increases in a direction toward the first substrate.

The PDP preferably further includes a dielectric layer interposed between the first substrate and the barrier ribs, the barrier ribs including a pigment forming a subtractive mixture with the dielectric layer.

The concentration of the pigment preferably increases in a direction toward the dielectric layer.

The PDP preferably further includes a second substrate facing the first substrate, the barrier ribs partitioning a discharge space between the first substrate and the second substrate to define a plurality of discharge cells.

The PDP preferably further includes a fluorescent layer arranged on the first substrate within the discharge cells.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is an exploded perspective view of a Plasma Display Panel (PDP) having barrier ribs including a black pigment having a predetermined concentration gradient, according to an embodiment of the present invention;

FIG. 2 is a graph of concentrations of a pigment and a glass powder according to the height of the barrier ribs of the PDP of FIG. 1;

FIG. 3 is a cross-sectional view of a PDP having barrier ribs including a first pigment having a predetermined concentration gradient and forming a subtractive mixture with a substrate, according to another embodiment of the present invention;

FIG. 4 is a cross-sectional view of a PDP having barrier ribs including a second pigment having a predetermined concentration gradient and forming a subtractive mixture with a dielectric layer, according to another embodiment of the present invention; and

FIG. 5 is a plane view of the PDP of FIGS. 3 or 4.

### DETAILED DESCRIPTION OF THE INVENTION

The present invention is described more fully below with reference to the accompanying drawings.

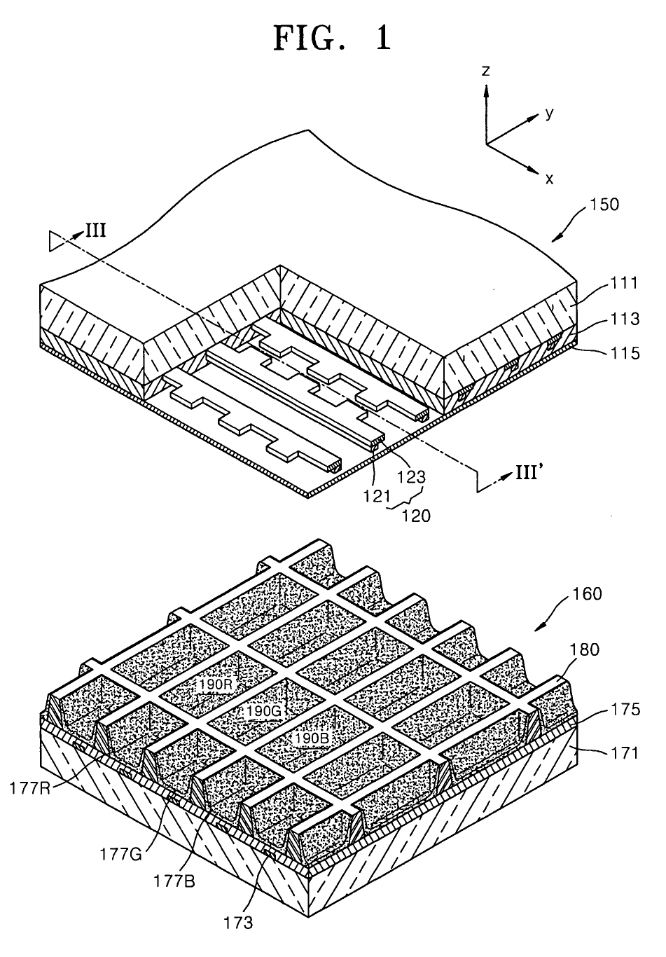

FIG. 1 is an exploded perspective view of a Plasma Display Panel (PDP) having barrier ribs including a black pigment having a predetermined concentration gradient, according to an embodiment of the present invention. The PDP includes an upper panel 150 and a lower panel 160, which are joined together and then sealed. Therefore, barrier ribs 180 contact the upper panel 150.

Referring to FIG. 1, the upper panel 150 includes a plurality of sustain discharge electrodes 120 that extend in an X-direction on a first substrate 111 and a first dielectric layer 113 covering the sustain discharge electrodes 120. A protective layer 115 is disposed on the first dielectric layer 113.

The first substrate 111 may be formed of a soda lime glass having excellent light permeability. In addition, the first substrate 111 may be colored in order to reduce reflection of external light, and thus improve bright room contrast.

The sustain discharge electrodes 120, which are disposed parallel to each other and extend in the X-direction on the first substrate 111, include an X-electrode and Y-electrode which respectively include a bus electrode 121 and a transparent electrode 123.

The bus electrodes 121 compensate for a relatively large resistance of the transparent electrodes 123 so that a nearly uniform voltage can be supplied to a plurality of discharge cells. The bus electrodes 121 may be formed of chrome (Cr), copper (Co), aluminum (Al), or the like.

Voltages are supplied to the transparent electrodes 123 to generate and sustain a discharge in the discharge cells 123. The transparent electrodes 123 maybe formed of a material having high visible light transmissivity and low electrode resistance, for example, Indium Tin Oxide (ITO).

In the first dielectric layer 113, a discharge current is restricted so as to sustain a glow discharge, and a memory function and voltage are reduced due to wall charge accumulation. In order to increase a discharge efficiency, a withstand voltage and visible light transmissivity must be high.

The protective layer 115 is formed of a material that has excellent plasma resistance to protect the first dielectric layer 113 and the sustain discharge electrode 120 from collisions with charged particles and has high secondary electron emission coefficient to reduce power consumption by lowering a voltage required to initiate a discharge and a voltage required to sustain the discharge. Furthermore, when the light is emitted through the first substrate 111, the material should not interfere with the transmission of visible light generated by the fluorescent materials due to its high light transmissivity. Magnesium oxide (MgO) may be used as the protective layer, and magnesium oxide (MgO) doped with other elements may also be used as desired.

The lower panel 160 facing the upper panel 150 includes a plurality of address electrodes 173 that extend in a Y-direction on a second substrate 171, and a second dielectric layer 175 covering the address electrodes 173. Barrier ribs 180 forming a plurality of discharge cells having rectangular cross-sections are disposed on the second dielectric layer 175 and fluorescent layers are disposed inside the discharge cells.

As with the first substrate 111, the second substrate 171 may be formed of a soda lime glass having excellent light permeability. In addition, the second substrate 171 may be colored in order to reduce the reflection of external light, and thus to improve bright room contrast.

The address electrodes 173 are disposed parallel to each other and extend in the Y-direction on the second substrate 171. The address electrodes 173 may also be formed of a conductive material, such as chrome (Cr), copper (Co), aluminum (Al), or the like so that a nearly uniform voltage can be supplied to a plurality of discharge cells, as with the bus electrode 121.

The second dielectric layer 175 protects the address electrode 173 from collisions with charged particles. In the second dielectric layer 175, a discharge current is restricted so as to sustain a glow discharge, and a memory function and a voltage are reduced due to wall charge accumulation.

The barrier ribs 180 are formed on the second dielectric layer 175 and partition a discharge space formed between the first substrate 111 and the second substrate 171 into a plurality of discharge cells. The barrier ribs 180 may have a matrix-type structure according to an embodiment of the present invention. However, the present invention is not limited thereto, and the barrier ribs 180 may also have a stripe-type structure and be formed so that cross-sections of the discharge cells have various different shapes such as a circular shape and a polygonal shape.

The barrier ribs 180 include a pigment whose concentration increases along a direction of light emitted outward from inside of the PDP. When light is emitted through the first substrate 111, the concentration of the pigment increases along the Z-axis. The pigment that absorbs external light may be a pigment coloring the barrier ribs black. The barrier ribs may be a dark color, such as brown and indigo blue, in addition to pure black.

A mixture of (Ti, Mn, Sb)O₂, and CuCr₂O₂, is used as the pigment, and TiO₂ as a white pigment is used to control brightness, according to an embodiment of the present invention. The concentration of the white pigment decreases along the Z-axis.

Furthermore, the barrier ribs 180 include a glass powder which is prepared by mixing ZnO, and Bi₂O₃, and the concentration of the glass powder decreases along the Z-axis.

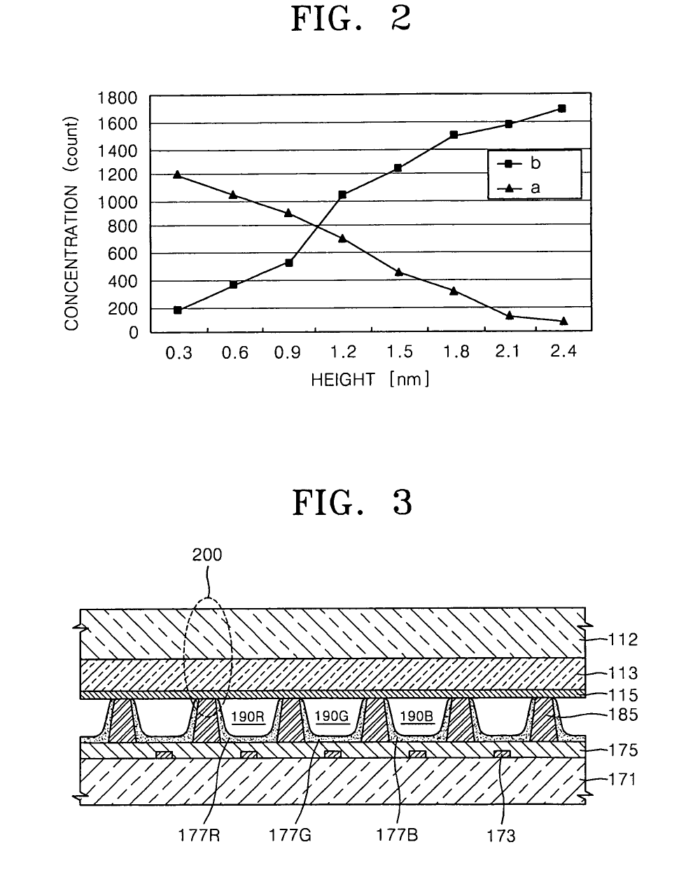

The concentration gradients of the pigment and glass powder according to the height of the barrier ribs 180 are shown in Table 1 and FIG. 2.

TABLE 1

| Height of barrier ribs | | |
|---|---|---|
| (μm) | Glass powder (count) | Pigment element (count) |
| 0.3 | 168 | 1208 |
| 0.6 | 365 | 1048 |
| 0.9 | 525 | 915 |
| 1.2 | 1051 | 718 |
| 1.5 | 1245 | 455 |
| 1.8 | 1488 | 312 |
| 2.1 | 1578 | 125 |
| 2.4 | 1688 | 83 |

Referring to Table 1 and FIG. 2, as the height of the barrier ribs 180 decreases, that is, along the Z-axis, the count of the pigment element (a) increases and the count of the glass powder (b) decreases.

The barrier ribs 180 including the pigment and glass powder having the above concentration gradients can be prepared according to following processes.

A glass powder powder and pigment element powder are mixed, and the mixture is further mixed with a binder and an organic solvent to prepare a paste. The paste is then coated on a substrate, and then sintered and etched to prepare the barrier ribs 180 having a predetermined pattern. The sintering may be performed at a temperature in the range of about 500 to 600°. During these processes, the glass powder having low glass transition temperature (Tg) and softening point (Ts) is sintered, and then the pigment element having relatively high glass transition temperature (Tg) and softening point (Ts) is distributed in a high concentration on the upper portion of the barrier ribs 180.

In addition, the glass powder is distributed in a high concentration at the lower portion of the barrier ribs 180, and thus, the lower portion of the barrier ribs 180 at which fluorescent layers are formed is brightly colored. Accordingly, the brightness losses of light emitted by the fluorescent layer is minimized.

A fluorescent layer is disposed in each of the discharge cells. In order to realize full-color displays, the fluorescent layer includes various colors. For example, when a color image is realized using the three primary colors of light, a red fluorescent layer 177R, a green fluorescent layer 177G, and a blue fluorescent layer 177B are alternately coated in the discharge cells to form a red discharge cell 190R, a green discharge cell 190G, and a blue discharge cell 190B.

The fluorescent layers are formed on the second substrate 171 and at the lower portion of the barrier ribs 180 in the discharge cells. The brightness of the lower portion of the barrier ribs 180 is higher than that of the upper portion of the barrier ribs 180. Thus, brightness losses are minimized by forming the fluorescent layers at the lower portion of the barrier ribs 180.

In addition, a discharge gas is injected into the discharge cells. The discharge gas may be an inert gas, such as neon (Ne), xenon (Xe), and helium or a mixture thereof.

The arrangement of elements, such as a substrate, an electrode, and a protective layer and materials forming the elements are not limited to the above described embodiments.

FIG. 3 is a cross-sectional view taken along line III-III′ of the PDP of FIG. 1. The PDP of FIG. 3 has barrier ribs include a first pigment having a predetermined concentration gradient and forming a subtractive mixture with a substrate, according to an embodiment of the present invention.

Referring to FIG. 3, a first substrate 112 is disposed to face a second substrate 171. Barrier ribs 185 are interposed between the first substrate 112 and the second substrate 171. The barrier ribs 185 include a first pigment having a concentration which increases in a direction toward of the first substrate 112. For example, the barrier ribs 185 may include (Ti,Mn,Sb)O₂ as a brown pigment.

Then, the first substrate 112 may include a second pigment which forms a subtractive mixture with the barrier ribs 180, for example, a blue pigment.

Accordingly, a region 200 in which the first substrate 112 overlaps the barrier ribs 185 is black. Bright room contrast is improved by reducing the reflection due to external light using the region 200.

The PDP according to the current embodiment includes sustain discharge electrodes on the first substrate 112, and a first dielectric layer 113 on the first substrate to cover the sustain discharge electrodes. Then, a protective layer 115 is formed on the first dielectric layer 113.

Address electrodes 173 are disposed on the second substrate 171 in a direction crossing the sustain discharge electrodes. A second dielectric layer 175 is formed on the second substrate 171 to cover the address electrodes 173.

In the PDP according to the current embodiment, the barrier ribs 185 are interposed between the protective layer 115 and the second dielectric layer 175 to form a plurality of discharge cells (190R, 190G, 190B). The fluorescent layers (177R, 177G, 177B) are formed on the second substrate 171, particularly on the second dielectric layer 175 in the discharge cells (190R, 190G, 190B). In addition, the fluorescent layers (177R, 177G, 177B) are coated on the barrier ribs 185, and the thickness of a lower portion of the fluorescent layers is relatively greater than that of an upper portion of the fluorescent layers. The upper portion of the barrier ribs 185 is close to the first substrate 112 and the lower portion is close to the second substrate 171.

Thus, since the barrier ribs 185 include a brown pigment in a relatively lower concentration at the lower portion, the reflection of light generated by the fluorescent layers (177R, 177G, 177B) having a great thickness is improved, and thus, brightness losses are minimized.

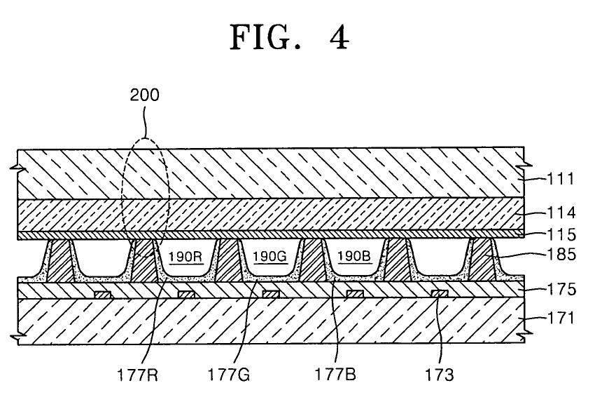

FIG. 4 is a cross-sectional view of a PDP having barrier ribs including a second pigment having a predetermined concentration gradient and forming a subtractive mixture with a dielectric layer, according to an embodiment of the present invention. More particularly, FIG. 4 is a sectional view of discharge cells of a PDP cut along a sustain discharge electrode.

Referring to FIG. 4, a first substrate 111 is formed of a soda lime glass having excellent light permeability. In addition, a first dielectric layer 114 formed on the first substrate 111 is colored with a pigment which forms a subtractive mixture with barrier ribs 185. When the barrier ribs 185 are colored brown, the dielectric layer 114 includes a blue pigment. Thus, a region 200 in which the barrier ribs 185 overlap the first dielectric layer 114 is black.

Other elements, such as a second dielectric layer 175, address electrodes 173, and fluorescent layers (177R, 177G, 177B) have been described above with reference to FIG. 3.

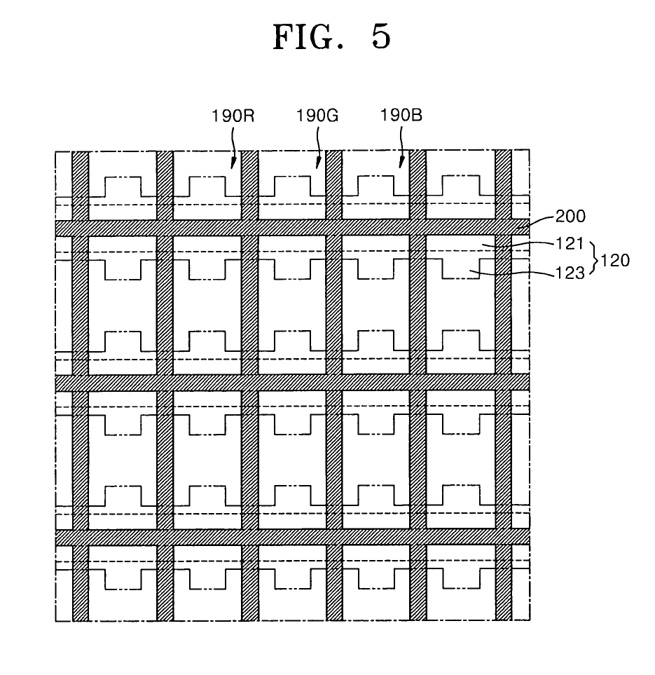

FIG. 5 is a plane view of the PDPs of FIGS. 3 or 4. Referring to FIG. 5, when the PDP is observed from the outside, black regions 200 exist along the barrier ribs 185 which partition a plurality of discharge cells (190R, 190G, 190B). In the regions 200, the first substrate 112 or the first dielectric layer 114 overlaps the barrier ribs 185. Since the regions 200 absorb external light, reflection due to external light is reduced.

Each of the discharge cells (190R, 190G, 190B) includes a sustain discharge electrode 120 which includes a bus electrode 121 and a transparent electrode 123.

According to the present invention, reflection due to external light is effectively reduced in the PDP since the barrier ribs include a black pigment having a predetermined concentration gradient.

In addition, brightness losses are minimized by including a fluorescent layer in the barrier ribs, the fluorescent layer having a relatively high brightness. More particularly, the concentration of the pigment in the barrier ribs increases in a direction toward the upper portion of the barrier ribs, and a fluorescent layer is disposed at the lower portion of the barrier ribs. Accordingly, reflection due to external light is effectively reduced since the black regions at the upper portion of the barrier ribs absorb the external light, and brightness losses are minimized by increasing the reflection of light emitted by the fluorescent layer.

Therefore, bright room contrast of the PDP according to the present invention is improved.

While the present invention has been particularly shown and described with reference to exemplary embodiments thereof, it will be understood by those of ordinary skill in the art that various modifications in form and detail may be made therein without departing from the spirit and scope of the present invention as defined by the following claims.

What is claimed is:

1. Barrier ribs to partition a discharge space to form a plurality of discharge cells of a Plasma Display Panel (PDP), the barrier ribs comprising:
a glass powder; and
a pigment having a varying concentration according to a height of the barrier ribs.

2. The barrier ribs of claim 1, wherein the concentration of the pigment increases in a direction of light emitted outward from inside of the PDP.

3. The barrier ribs of claim 1, wherein the pigment absorbs external light.

4. The barrier ribs of claim 1, wherein the pigment comprises a black pigment.

5. The barrier ribs of claim 1, wherein the pigment is selected from a group consisting of CuO, Cr₂O₃, MnO, CoO, Fe₂O₃, (Ti, Mn, Sb)O₂, CuCr₂O₂ and a combination of at least two of these compounds.

6. The barrier ribs of claim 1, wherein the concentration of the glass powder decreases in a direction of light emitted outward from inside of the PDP.

7. The barrier ribs of claim 1, wherein the glass powder is selected from a group consisting of SiO₂, ZnO, Bi₂O₃, PbO, B₂O₃, Al₂O₃, ZnO and a combination of at least two of these compounds.

8. A Plasma Display Panel (PDP) comprising:
a first substrate; and
barrier ribs disposed on the first substrate, the barrier ribs including a glass powder and a pigment having a varying concentration according to a height of the barrier ribs.

9. The PDP of claim 8, wherein the concentration of the pigment increases in a direction of light emitted outward from inside of the PDP.

10. The PDP of claim 8, wherein the barrier ribs comprise a pigment forming a subtractive mixture with the first substrate.

11. The PDP of claim 10, wherein the concentration of the pigment increases in a direction toward the first substrate.

12. The PDP of claim 8, further comprising a dielectric layer interposed between the first substrate and the barrier ribs, wherein the barrier ribs include a pigment forming a subtractive mixture with the dielectric layer.

13. The PDP of claim 12, wherein the concentration of the pigment increases in a direction toward the dielectric layer.

14. The PDP of claim 8, further comprising a second substrate facing the first substrate, wherein the barrier ribs partition a discharge space between the first substrate and the second substrate to define a plurality of discharge cells.

15. The PDP of claim 14, further comprising a fluorescent layer arranged on the first substrate within the discharge cells.

16. The barrier ribs of claim 1, wherein the glass transition temperature (Tg) of the glass powder is lower than that of the pigment.

17. The barrier ribs of claim 1, where in the softening point (Ts) of the glass powder is lower than that of the pigment.

18. The PDP of claim 8, wherein the glass transition temperature (Tg) of the glass powder is lower than that of the pigment.

19. The PDP of claim 8, wherein the softening point (Ts) of the glass powder is lower than that of the pigment.
